(19) United States
(12) Patent Application Publication
(10) Pub. No.: US 2019/0373040 A1
(43) Pub. Date: Dec. 5, 2019

(54) SYSTEMS AND METHODS GAME STREAMING

(71) Applicant: Infiniscene, Inc., Chicago, IL (US)

(72) Inventors: Stuart Grubbs, Chicago, IL (US); John Bradley, Chicago, IL (US); William A. Kelleher, Chicago, IL (US)

(21) Appl. No.: 16/404,034

(22) Filed: May 6, 2019

Related U.S. Application Data
(60) Provisional application No. 62/678,141, filed on May 30, 2018.

(51) Int. Cl. H04L 29/06; A63F 13/355; H04N 19/513

(52) U.S. Cl. CPC H04L 65/607; H04N 19/513; A63F 13/355; H04L 65/608

(57) ABSTRACT

Systems and methods for stream data encoding.

### CROSS-REFERENCE TO RELATED APPLICATIONS

This application claims the benefit of U.S. Provisional Application No. 62/678,141 filed 30 May 2018, which is incorporated in its entirety by this reference.

### TECHNICAL FIELD

This disclosure relates generally to video streaming, and more specifically to new and useful systems and methods for video streaming of game play.

### BACKGROUND

Video streaming ordinarily involves use of either a software or a hardware video encoder to encode video into a format suitable for streaming.

### BRIEF DESCRIPTION OF THE FIGURES

FIGS. 1A-B are schematic representations of systems, according to embodiments;

FIG. 2 is a representation of a program engine, according to embodiments;

FIG. 3 is a representation of an encoding module, according to embodiments;

FIG. 4 is a representation of a method, according to embodiments;

FIGS. 5A-B are diagrams depicting system architecture of systems, according to embodiments.

### DESCRIPTION OF EMBODIMENTS

The following description of embodiments is not intended to limit the disclosure to these embodiments, but rather to enable any person skilled in the art to make and use the embodiments disclosed herein.

1. Overview

Live data streaming (e.g., video streaming, audio streaming) ordinarily involves processing raw data (e.g., video data, audio data) by using an encoder to generate encoded content suitable for streaming, and transmitting the encoded content to a device that is constructed to decode the encoded content. The encoding process ordinarily involves use a CPU (central processing unit). During execution of a program (e.g., video game program) by a device (e.g., a general purpose computer, a mobile device, a special purpose gaming device and the like), a CPU of the device executes program instructions of the program. In a case where the CPU of the device is simultaneously executing program instructions of the program while encoding output generated by the program, program performance and streaming performance can be impacted. It is desirable to provide streaming performance that satisfies a set of streaming performance (and/or quality) constraints, while also providing a program experience that also satisfies a set of performance (and/or quality) constraints. For example, in a scenario in which spectators watch one or more users playing a game, it is desirable to control processing load of the CPU to reduce negative impact on gameplay performance as perceived by a game player while providing a quality video stream that is desirable for spectators that are viewing streamed video game output of the gameplay session.

During conventional game video encoding, game engines render a complete scene to a frame buffer, and this buffer is passed to the video encoder like any other video frame. However, scene context that resides in the game engine is not ordinarily passed to the video encoder, and the encoder is left to divine all of the information that it needs from the raw frames. Some of these tasks, such as, for example, Motion Estimation and Motion Compensation, are actually some of the most computationally expensive stages in encoding. Given the recent rise of game streaming to services like Twitch and Mixer, as well as the introduction of cloud-based gaming services that stream games directly to the player as encoded video, anything that can be done to either reduce the resource cost of encoding game video or increase the quality of the encoding compared to existing naive solutions would be incredibly valuable.

By integrating video encoding more tightly into a game engine performance, quality can be improved beyond what is capable in an existing naive encoding solution. Embodiments herein provide integration of video encoding with a program engine (e.g., game engine) by using an encoding module (e.g., 110) that performs video encoding in accordance with program information provided by the program engine (e.g., via an API 112 of the encoding module). In some embodiments, by virtue of the encoding module leveraging program information that includes state and semantics received from the program engine (e.g., 120a, 120b) (e.g., a video game engine), the encoding module may enable more efficient encoding of a scene output (provided by the program engine to the encoding module) into video bitstream (e.g., video stream output to be provided to a consuming device) in a variety of modern video codecs. Tightly coupling this capability with a game engine may reduce the likelihood that external frame capture and encoding negatively impacts performance of the program engine (e.g., game engine), because the engine will be free to schedule the encoding work directly. In some embodiments, in a case where encoding by the encoding module negatively impacts performance of the program engine, the program engine provides program information to the encoding module to update the encoding process to reduce performance impact on the program engine.

In some embodiments, video encoding by the encoding module includes at least one of: 1) intra-coding based on scene composition; 2) inter-coding and motion vector calculation based on scene composition; and 3) bit allocation based on scene composition. In some embodiments, program information identifying scene composition and/or scene semantics of a scene (to be encoded) is provided to the encoding module, and the encoding module performs encoding based on at least one of scene composition and scene semantics. For example, program information can identify a scene as including a tree fixed to a background, and/or an avatar of a user that is likely to move freely relative to a background, and the encoding module can use this information to perform encoding in a suitable manner.

In some embodiments, intra-coding includes creating an independently decodable frame (e.g., an I-frame in H.264). In codecs that support variable-size blocks (e.g., VP9, H.265), the scene composition identified by the program information (provided by the program engine to the encoding module) is used (e.g., at S401) to guide the block partitioning to isolate different types of objects in the scene that are likely to move independently of one-another.

In some embodiments, inter-coding includes encoding a frame based on differences between the current frame and some number of reference frames. Modern video codecs use a technique called Motion Estimation to analyze adjacent frames and predict if blocks are moving, then use this information to generate Motion Vectors to describe the motion and improve compression. This process is one of the most expensive stages in encoding video; however, in a game, the motion of objects in a scene is already known before the scene is completely rendered and this information can be used to more accurately generate Motion Vectors while saving the expense of Motion Estimation. In some embodiments, the program information identifies motion of objects in the scene to be encoded, at S401 (described herein) the encoding module uses the program information to generate motion vectors, and the encoding module performs compression based on the motion vectors. By virtue of the program information identifying motion of objects, and using the program information to generate motion vectors, compression based on scene motion can be performed without also performing a Motion Estimation process, thereby improving performance. In some embodiments, bit allocation includes quantization. In some embodiments, quantization includes, during video encoding, compressing a transformation of residual pixel values in a block (in a frequency domain) to remove high-frequency values. In some embodiments, the degree of compression is controlled by a Quantization Parameter, and the Quantization Parameter (QP) can vary on a per-block basis. In some embodiments, a rate control algorithm is used to adjust the QP on a per-frame or per-block basis. In some embodiments, in the context of a rendered scene in a game, there have already been multiple decisions on the importance of a node in the scene graph; whether it be fog, depth-of-field, or any other tool used to visually indicate the importance of a particular object, the game engine already has a clear concept of the levels of detail for everything being displayed. In some embodiments, the program information identifies a Semantic Scene Quantization (SSQ) value that conveys this contextual information about scene details to augment the quantization process (performed by the encoding module, e.g., at S401) and intelligently scale the QP assignment on a per-block basis within a frame; this is not ordinarily possible by conventional encoders because they do not typically have access to information that identifies what comprises the scene and conventional encoders typically make inferences from various techniques detecting lines and general shapes.

Embodiments herein provide systems and methods for allocating encoding processing tasks to at least one hardware device to satisfy both streaming constraints and program performance constraints. Some embodiments herein provide systems and methods for selecting encoding parameters for encoding output of a program. Some embodiments herein provide systems and methods for generating a hardware profile of a device, for use in selecting encoding parameters. Some embodiments herein provide systems and methods for providing an API for use by a program engine to provide programmatic control of streaming of output of the program by the program engine.

In some embodiments, an encoding module determines an encoding profile that specifies hardware encoding devices, input sources, and software encoding capabilities of a system (e.g., a gaming system). In some embodiments, the encoding module determines an initial encoding workflow based on the encoding profile and initial streaming parameters, wherein the initial workflow specifies an assignment of at least one encoding process to at least one hardware encoding device of the encoding profile, by using one of a statistical analysis process and a machine learning process. Responsive to an input capture request received via an API from a program engine (e.g., of a video game program), data (e.g., audio data, video data) specified by the input capture request is encoded in accordance with the initial encoding workflow. In some embodiments, responsive to streaming feedback information received from a streaming destination and CPU utilization data received from an Operating System of the system (e.g., gaming system), the encoding workflow is incrementally updated by applying one of the machine learning process and the statistical analysis process to the feedback information, the CPU utilization data, and the encoding profile, within a time window, and the streaming is updated by using the updated encoding workflow. In some embodiments, the machine learning process determines a workflow that optimizes a selected optimization target, wherein the target is updated based on the feedback information and the CPU utilization data. In some embodiments, the statistical analysis process determines a workflow that optimizes a selected optimization target, wherein the target is updated based on the feedback information and the CPU utilization data.

In some embodiments, logic (e.g., game logic) of the program engine controls selective insertion of assets into the encoded stream (e.g., audio stream, video stream). In some embodiments, game logic of the program engine controls selective tagging of the encoded stream (e.g., audio stream, video stream) with game telemetry.

In some embodiments, the machine learning process generates a workflow that satisfies both CPU performance constraints and streaming quality constraints, and updates the workflow as monitored CPU utilization and streaming performance changes.

In some embodiments, the encoding workflow is generated by using the encoding profile and initial encoding parameters. In some embodiments, the encoding workflow is updated based on the encoding profile, video streaming quality feedback, monitored CPU utilization of the gaming system, streaming performance constraints, and CPU utilization constraints. In some embodiments, the encoding workflow is updated based on the encoding profile, video streaming quality feedback, monitored CPU utilization of the gaming system, estimated user bandwidth, streaming performance constraints, and CPU utilization constraints.

In some embodiments, CPU program (e.g., gaming) performance is balanced with streaming (e.g., audio, video) quality dynamically in real-time during program execution (e.g., game play) such that both CPU performance constraints and streaming quality constraints are both satisfied. In some embodiments, CPU performance is balanced with streaming quality, and streaming dimensions dynamically in real-time during program execution, such that both CPU performance constraints and streaming quality constraints are both satisfied.

In some embodiments, program logic (e.g., game logic) is used to selectively insert assets (e.g., audio assets, video assets) into a generated stream by using an API of the encoding module. In some embodiments, assets include advertisement assets. In some embodiments, assets include marketing assets.

In some embodiments, program logic (e.g., game logic) is used to control editing of the stream (e.g., controlling scene changes of a video stream, etc.) of the stream by using an API of the encoding module. In some embodiments, program logic (e.g., game logic) is used to control editing of the stream based on in-program events (e.g., in-game events). In some embodiments, CDN-based feedback (such as user count, activity and the like) is used to control editing of the stream (e.g., controlling scene changes of a video stream, etc.) of the stream by using an API of the encoding module. In some embodiments, CDN-based feedback (such as user count, activity and the like) is used to control editing of the stream based on in-program events (e.g., in-game events).

In some embodiments, program logic (e.g., game logic) is used to selectively tag a generated stream (e.g., audio stream, video stream) by using an API of the encoding module. In some embodiments, tags include metadata. In some embodiments, the metadata includes game telemetry.

In some embodiments, high-quality live streaming and simultaneous high performance gaming is provided by managing hardware resources of a computer system that performs both program execution and encoding (e.g., audio encoding, video encoding). In some embodiments, assets are automatically inserted in a stream (e.g., audio stream, video stream) to create an enhanced composite stream for consumption by content consumers (e.g., video game spectators).

In some embodiments, an encoding module determines the initial encoding workflow responsive to a start session request. In some embodiments, the start session request specifies session parameters. In some embodiments, the encoding module determines the initial encoding workflow based on the session parameters of the start session request. In some embodiments, the session parameters of the start session request include at least one of: encoding parameters, video quality constraints, audio quality constraints, CPU utilization constraints, and program (e.g., game) performance constraints.

In some embodiments, the input capture request specifies input capture parameters (e.g., audio capture, video capture), and data specified by the input capture instruction is encoded in accordance with the capture parameters of the input capture request. In some embodiments, the input capture parameters of the input capture request include at least one of: encoding parameters, video quality constraints, audio quality constraints, CPU performance constraints. In some embodiments, the input capture request specifies the data to be encoded. In some embodiments, the input capture request specifies at least one asset to be included in the generated stream. In some embodiments, the input capture request specifies position information of at least one asset for positioning of the asset within a frame of a video stream. In some embodiments, the input capture request specifies information of at least one audio asset for inclusion within an audio stream.

In some embodiments, encoding parameters include at least one of: quality balance, max bitrate, buffer size, constant bitrate (CBR) encoding settings (e.g., 1-pass, 2-pass, multi-pass), variable bitrate (VBR) encoding settings (e.g., 1-pass, 2-pass, multi-pass), audio codec, audio encoding format, audio encoding bitrate, audio encoding channel (e.g., stereo, mono, etc.). In some embodiments, encoding parameters include at least one of a QP (Quantizer Parameter) of I frames, a QP of P frames, and a QP of B frames. In some embodiments, encoding parameters include at least one tuning encoding parameter. In some embodiments, at least one tuning encoding parameter overrides a default encoder configuration parameter.

In some embodiments, responsive to an asset insertion instruction received by the encoding module via an API from a program engine (e.g., of a video game program), an asset specified by the asset instruction is included in the encoded stream. In some embodiments, the asset insertion instruction specifies position information of at least one asset for positioning of the asset within a frame of the video stream. In some embodiments, the asset insertion instruction specifies information of at least one audio asset for inclusion within an audio stream.

In some embodiments, the encoding module determines the encoding profile by querying an operating system (OS) of the gaming system. In some embodiments, the encoding module determines the encoding profile by querying a registry of the operating system (OS) of the gaming system. In some embodiments, the encoding module determines the encoding profile by querying hardware devices communicatively coupled to a bus of the gaming system.

In some embodiments, a Streaming Development Kit (GSDK) module is provided. In some embodiments, the GSDK module includes an application programming interface (API) that is constructed to enable programs (e.g., video game programs games developed by game studios or other software makers) to add streaming or highlight clipping as a native feature of the game or software. As an example, a user (e.g., a gamer) simply links their Facebook account in-game and presses a start-streaming button provided in a user interface of the program to share their program interaction experience (e.g., gaming experience) to Facebook. As an example of highlight clipping, in response to a particular program event (e.g., a gaming event of a video game) a user presses a button and the program saves the last 30 seconds or 15 seconds as a clip for the user to share anywhere. As an example of asset insertion, in response to a particular program event (e.g., a gaming event of a video game), the program uses the API of the GSDK module to insert an asset into the video stream.

In some embodiments, the computer system (e.g., gaming system) includes a plurality of hardware encoding devices.

2. Systems

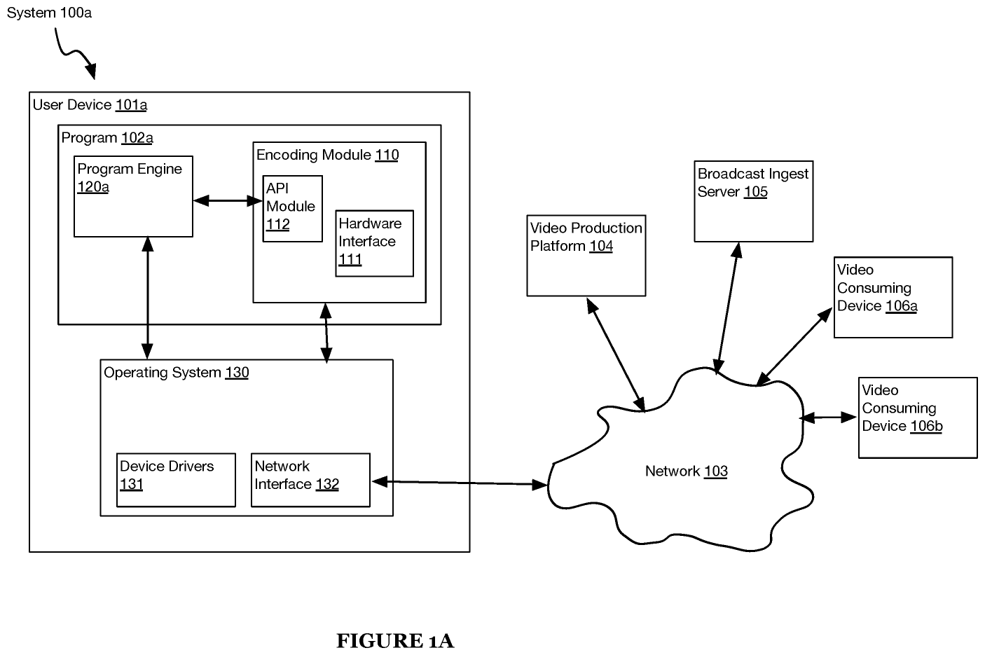

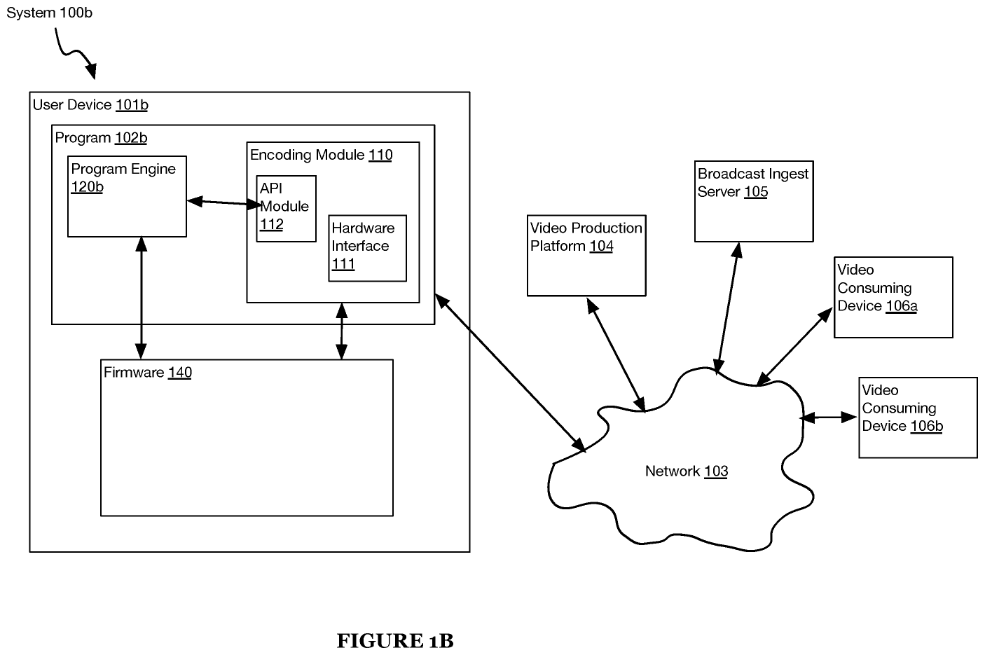

FIGS. 1A-B are schematic representations of systems, according to embodiments. The system 100a of FIG. 1A includes a user device 101a with an operating system 130 (e.g., a laptop computer, desktop computer, mobile device, and the like). The device 101a also includes a program 102a (application module) that is constructed to interface with the operating system 130. The operating system 130 includes device drivers 131 and a network interface 132. The program 102a is constructed to use the operating system 130 to interface with other devices (e.g., video production platform 104, broadcast ingest server 105, video consuming devices 106a-b, etc.) that are communicatively coupled to the network 103.

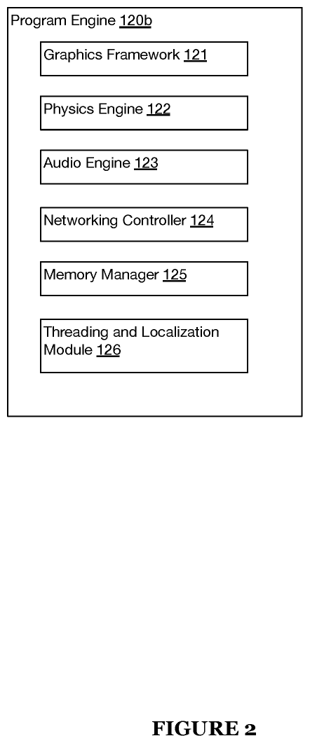

The system 100b of FIG. 1B includes a user device 100b (e.g., a gaming device) that includes firmware 140. The device 100b also includes a program 102b that is constructed to interface with the firmware 140. The program 102b is constructed to interface with other devices (e.g., video production platform 104, broadcast ingest server 105, video consuming devices 106a-b, etc.) that are communicatively coupled to the network 103. In some embodiments, the program 102b is constructed to interface with other devices (e.g., video production platform 104, broadcast ingest server 105, video consuming devices 106a-b, etc.) that are communicatively coupled to the network 103 by using a networking controller (e.g., 124 of FIG. 2) of the program 102b.

In some embodiments, each program 102a and 102b includes a program engine (120a, 120b) and an encoding module 110. In some embodiments, the encoding module includes an application programming interface (API) module 112 and a hardware interface module 111. In some embodiments, the program engine 120a is constructed to interface with the encoding module 110 via the API module 112. In some embodiments, the program engine 120b is constructed to interface with the encoding module 110 via the API module 112.

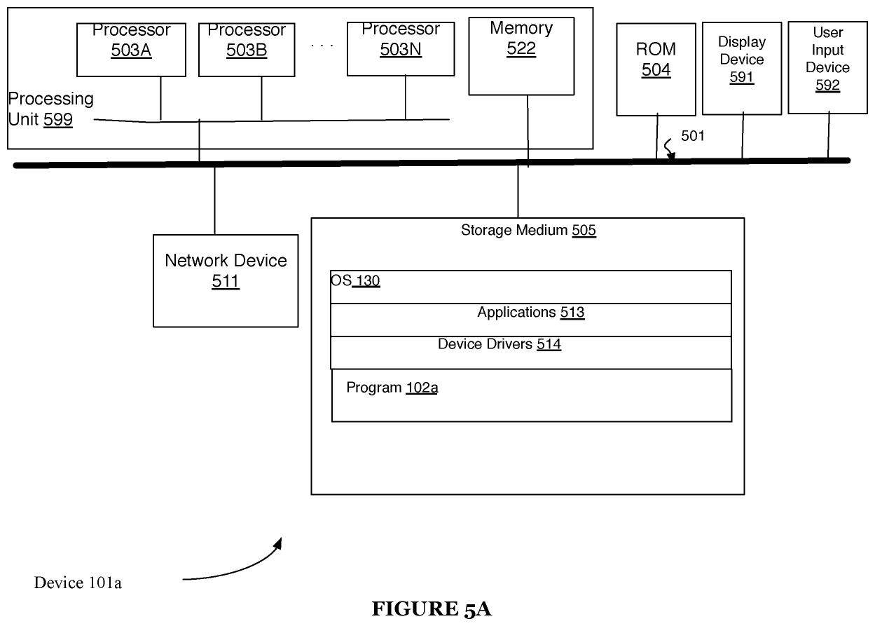

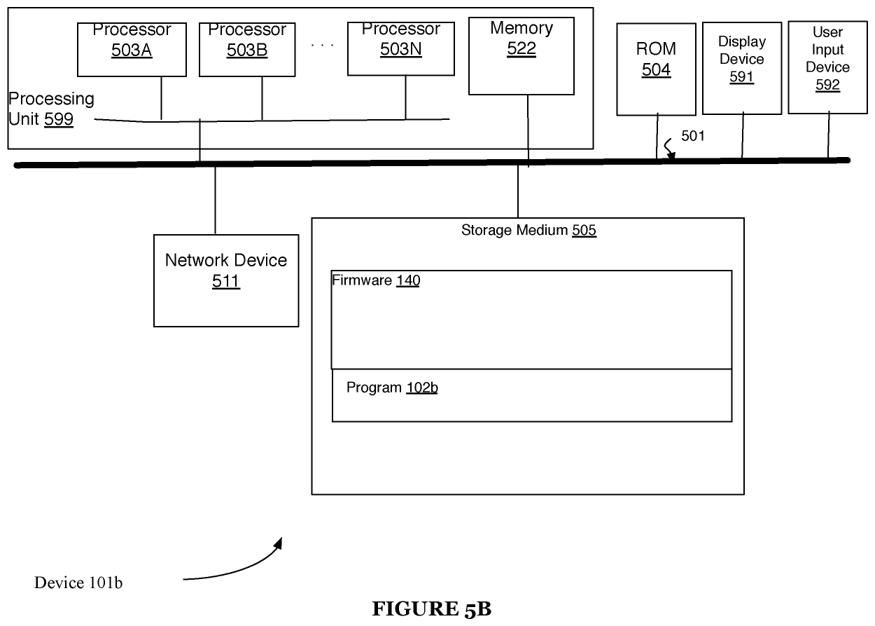

In some embodiments, the hardware interface in of includes device drivers (e.g., display drivers) for communicating with each hardware encoding device that is communicatively coupled to a hardware bus (e.g., 501 of FIGS. 5A-B) of the user device (e.g., 101a, 101b) that hosts the hardware interface 111. In some embodiments, the hardware interface in includes multiple versions of device drivers for at least one hardware encoding device. In some embodiments, at least one version of a device driver is included in a sandbox application. In some embodiments, the hardware interface in of includes application programming interfaces (APIs) (e.g., NVENCODE APIs, Intel Media SDK APIs, AMF SDK APIs, AMD Media SDK APIs, and the like) for communicating with each hardware encoding device that is communicatively coupled to a hardware bus (e.g., 501 of FIGS. 5A-B) of the user device (e.g., 101a, 101b) that hosts the hardware interface 111. In some embodiments, the hardware interface 111 includes multiple versions of APIs for at least one hardware encoding device. In some embodiments, at least one version of an API is included in a sandbox application. In some embodiments, the hardware interface 111 includes computer-executable program instructions for communicating with at least one hardware encoding device that is communicatively coupled to a hardware bus (e.g., 501 of FIGS. 5A-B) of the user device (e.g., 101a, 101b) that hosts the hardware interface 111. In some embodiments, hardware encoding devices communicatively coupled to the hardware bus include processor hardware encoding devices (e.g., encoding devices included in a processor) and graphics card encoding devices (e.g., encoding devices included in a graphics card device.

In some embodiments, the program engine 120a is constructed to interface with the operating system 130. In some embodiments, the encoding module 110 is constructed to interface with the operating system 130.

In some embodiments, the program engine 120b is constructed to interface with the firmware 140. In some embodiments, the encoding module 110 is constructed to interface with the firmware 140.

FIG. 2 depicts and embodiment of the program engine 120b. In some embodiments, the program engine 120b includes at least one of a graphics frameworks 121, a physics engine 122, an audio engine 123, the networking controller 124, a memory manager 125, and a threading and localization module 126.

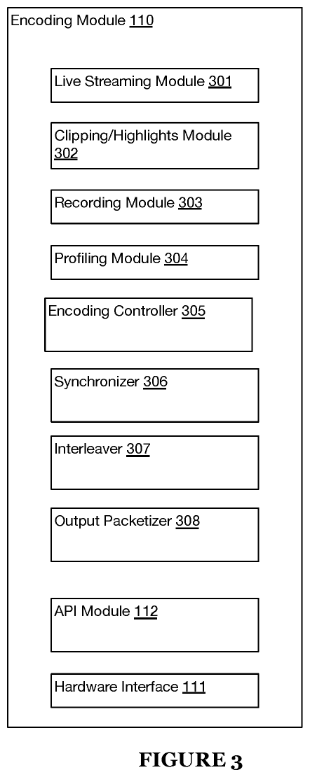

FIG. 3 depicts and embodiment of the encoding module 110. In some embodiments, the encoding module 110 includes at least one of a live streaming module 301, a clipping and highlights module 302, a recording module 303 a profiling module 304, an encoding controller 305, a synchronizer 306, an interleaver 307, and a packetizer 308.

In some embodiments, the programs 102a and 102b are video game programs. In some embodiments, the programs 102a and 102b are programs that are different from video game programs. In some embodiments, the programs 102a and 102b are video editing programs. In some embodiments, the programs 102a and 102b are video compositing programs.

In some embodiments, the programs 102a and 102b are application modules that include machine-executable program instructions and application data. In some embodiments, application data includes at least one of configuration information, image data, audio data, video data, an electronic document, an electronic file, and the like.

3. Methods

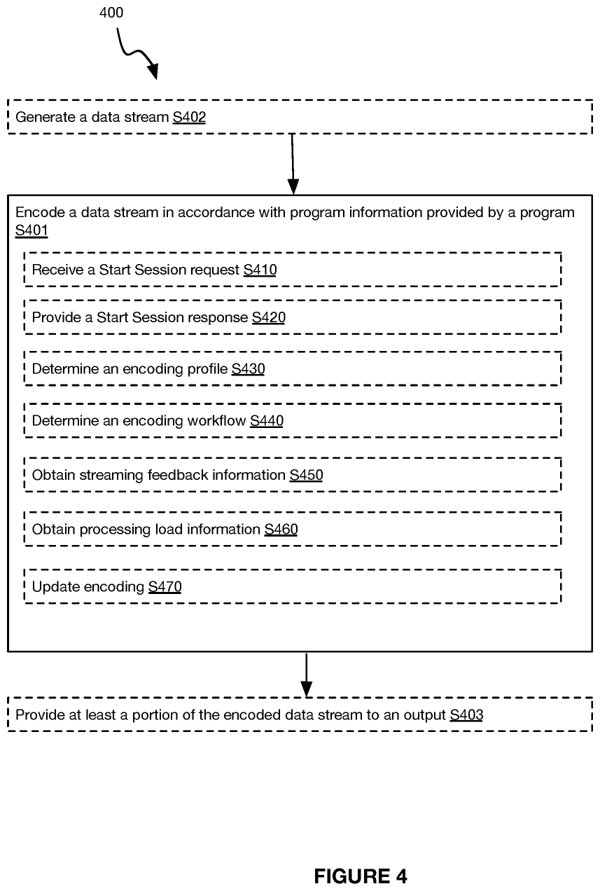

FIG. 4 is a representation of a method, according to embodiments. In some embodiments, the method 400 of FIG. 4 includes: encoding a data stream in accordance with program information provided by a program (e.g., 102a, 102b) (S401). In some embodiments, the encoding is performed by an encoding module (e.g., no), and a program engine (e.g., 120a, 120b) provides the program information to the encoding module (e.g., via an API module 112 of the encoding module). In some embodiments, the program generates the data stream. In some embodiments, a program engine of the program provides the program information and generates the data stream. In some embodiments, the data stream is an audio stream, and the program is a driver of a peripheral device (e.g., a headphone, a mouse, a keyboard, etc.). In some embodiments, the data stream is a video stream, and the program is a driver of a peripheral device (e.g., a headphone, a mouse, a keyboard, etc.). In some embodiments, the data stream is a video steam generated by a program engine. In some embodiments, the program engine is a game engine of a video game program.

In some embodiments, the program information identifies content of the data stream. In some embodiments, the program information identifies audio information of the data stream. In some embodiments, audio information includes at least one of speaker identification information, speech detection information, keyword detection information. In some embodiments, the program information identifies video information of the data stream. In some embodiments, video information includes at least one of a color pallet of at least a portion of the video stream, an amount of motion detected in at least a portion of the video stream, identification of one or more objects detected in at least a portion of the video stream, spatial characteristics of at least a portion of the video stream, temporal characteristics of at least a portion of the video stream, and an importance level of at least a portion of the video stream. In some embodiments, the program information includes an encoding session start request. In some embodiments, the program information includes an input capture request that identifies at least the data stream to be encoded at S401.

In some embodiments, S401 includes encoding a data stream by performing intra-encoding (as described herein). In some embodiments, the program information identifies a scene composition for at least one video frame of the data stream, and the encoding module uses the scene composition information to perform block partitioning to isolate different types of objects in the scene that are likely to move independently of one-another. In some embodiments, the encoding module performs a different encoding process for at least two partitioned blocks.

In some embodiments, S401 includes encoding a data stream by performing inter-encoding (as described herein). In some embodiments, the program information identifies motion of objects in the scene to be encoded, and the encoding module uses the program information to generate motion vectors, and the encoding module performs compression based on the motion vectors. By virtue of the program information identifying motion of objects, and using the program information to generate motion vectors, compression based on scene motion can be performed without also performing a Motion Estimation process, thereby improving performance.

In some embodiments, S401 includes encoding a data stream by performing quantization (as described herein). In some embodiments, performing quantization includes, during video encoding, compressing a transformation of residual pixel values in a block (in a frequency domain) to remove high-frequency values. In some embodiments, the degree of compression is controlled by a Quantization Parameter, and the Quantization Parameter (QP) can vary on a per-block basis. In some embodiments, the encoding module uses a rate control algorithm to adjust the QP on a per-frame basis. In some embodiments, the encoding module uses a rate control algorithm to adjust the QP on a per-block basis. In some embodiments, the program information identifies a Semantic Scene Quantization (SSQ) value that conveys this contextual information about scene details to augment the quantization process (performed by the encoding module, e.g., at S401) and intelligently scale the QP assignment on a per-block basis within a frame.

In some embodiments, the encoding is performed by using a software encoder. In some embodiments, the encoding is performed by using a hardware encoder. In some embodiments, the encoding is performed by using a combination of one or more of a software encoder and a hardware encoder.

In some embodiments, the method 400 includes: a program engine of the program generating the data stream (S402).

In some embodiments, the method 400 includes: providing at least a portion of the encoded data stream to an output (S403).

In some embodiments, the method 400 is performed by an encoding module (e.g., no). In some embodiments, the encoding module is included in an SDK (Software Development Kit). In some embodiments, the encoding module includes hardware encoding device application programming interfaces (APIs) (e.g., NVENCODE API, Intel Media SDK APIs, AMF SDK APIs, AMD Media SDK APIs) for a plurality of hardware encoding devices (e.g., Nvidia Nvenc, Intel, and AMD hardware encoding devices). In some embodiments, the encoding module includes a plurality of versions of APIs for at least one hardware encoding device (e.g., a plurality of versions of the NVENCODE API). In some embodiments, at least one API included in the encoding module is included in a sandbox application.

In some embodiments, the method 400 is performed by a user device (e.g., 101a, 101b). In some embodiments, the method 400 is performed by a computer system (e.g., 101a, 102b) in response to execution of machine executable instructions of a program (e.g., 102a, 102b) stored on a non-transitory computer-readable storage medium of the computer system.

In some embodiments, the method 400 includes: an encoding module (e.g., 110) of the program determining an encoding profile (S430). In some embodiments, the encoding profile identifies device drivers included in a computer system that includes the program. In some embodiments, the encoding profile identifies an operating system (or firmware) of a computer system that includes the program. In some embodiments, the encoding profile identifies at least one of hardware encoding devices, software encoding capabilities, input sources, local outputs, and network outputs of a computer system (e.g., 101a, 101b) that includes the program. In some embodiments, S430 is performed by a profiling module (e.g., 304) of the encoding module. In some embodiments, the method 400 includes: the encoding module receiving a start session request from a program engine (e.g., 120a, 120b) of the program via an API module (e.g., 112) of the encoding module 110 (S410), responsive to the start session request, the encoding module sending a start session response to the program engine indicating that the encoding module is ready to process an input capture request (S420), and responsive to the encoding module receiving an input capture request from the program engine via the API module, the encoding module determining the encoding profile (S430).

In some embodiments, the method 400 includes: the encoding module determining an initial encoding workflow based on the encoding profile (S440). In some embodiments, S440 is performed responsive to determining the encoding profile. In some embodiments, the encoding module determines the initial encoding workflow based on the encoding profile and initial encoding parameters. In some embodiments, the initial workflow specifies an assignment of at least one encoding process to at least one hardware encoding device of the encoding profile. In some embodiments, the encoding profile identifies hardware encoders available at the computer system, and determining the initial encoding workflow includes selecting a hardware encoding device API for at least one identified hardware encoder. In some embodiments, the encoding profile identifies hardware encoders available at the computer system and installed display drivers, and determining the initial encoding workflow includes selecting a hardware encoding device API for at least one identified hardware encoder that is compatible with at least one installed display driver. In some embodiments, determining the initial encoding workflow includes selecting initial encoding parameters. In some embodiments, the encoding module uses the initial encoding workflow to encode the data stream at S401.

In some embodiments, S440 includes: the encoding module using a trained workflow selection model to select an encoding workflow based on the encoding profile. In some embodiments, the workflow selection model is trained on a dataset that includes historic encoding profiles and corresponding encoding workflows, and the workflow selection model is trained to predict an encoding workflow for an input data set that represents an encoding profile.

In some embodiments, providing at least a portion of the encoded data stream to an output (S403) includes: responsive to encoding at S401, the encoding module providing the encoded data stream to one of a local output and a network output.

In some embodiments, providing at least a portion of the encoded data stream to an output includes: providing at least a portion of the encoded data stream to an output in response to an instruction received from the program engine.

In some embodiments, providing at least a portion of the encoded data stream to an output comprises: providing at least a portion of the encoded data stream to an output in response to detection of a debugging event of the program engine. In some embodiments, the debugging event is identified by a message received from the program engine. In some embodiments, the debugging event is a failure event of the program engine detected by the encoding module. In some embodiments, the debugging event is a program anomaly. In some embodiments, the debugging event is an error condition. In some embodiments, the debugging event is a program fault. By virtue of performing encoding using an encoding module that is separate from the program engine, streaming can be performed even if the program engine fails. In some embodiments, the encoding module stores stream data in a buffer (e.g., by using at least one of a clipping module 302, a recording module 303, and the like), and automatically encodes and streams the stream data in the buffer in response to a debugging event of the program engine. In this manner, stream data related to debugging events is automatically streamed to an output in response to the debugging event.

In some embodiments, the method 400 includes: obtaining updated program information from a program engine of the program (e.g., via the API module 112), updating an encoding workflow used for the encoding (at S401) based on the updated program information, and encoding the data stream in accordance with the updated workflow. In some embodiments, the workflow is updated based on at least one of speaker identification information, speech detection information, keyword detection information, a color pallet of at least a portion of the video stream, an amount of motion detected in the at least a portion of the video stream, identification of one or more objects detected in at least a portion of the video stream, and an importance level of at least a portion of the video stream, provided by the program information (e.g., via the API module 112).

In some embodiments, encoding is updated to enhance quality if the program information indicates that a current portion of the stream contains important information. In some embodiments, the program information includes a description of the content of the current portion of the stream, and the encoder can increase or decrease output quality based on the description of the content. For example, if the program information indicates that video stream includes faces, the encoding module can increase encoding quality. By virtue of the foregoing, the encoding module can update encoding parameters based on content of the stream (audio or video) to provide higher quality encoding for certain types of content and lower quality (but less processing intensive) encoding for other types of content. Because the program engine provide the content information to the encoding module, the encoding module does not need to perform a content analysis process, which could be more processor intensive (and less accurate) than information directly provided from the program engine. In other words, the encoding module can enhance quality for “interesting” content in real-time, and reduce quality for less interesting content in order to reduce processing load on the system. In some embodiments, the encoding module includes one or more content-based encoding workflow selection processes (either rule-based or machine learning-based) to select an encoding workflow based on program information provided by the program engine.

In some embodiments, the method 400 includes: obtaining streaming feedback information (S450), updating an encoding workflow used for the encoding (at S401) based on the streaming feedback information, and encoding the data stream in accordance with the updated workflow.

In some embodiments, the method 400 includes: obtaining processing load information (S460), updating an encoding workflow used for the encoding (at S401) based on the processing load information, and encoding the data stream in accordance with the updated workflow.

In some embodiments, updating the encoding workflow includes updating the encoding workflow to enhance quality (e.g., video quality, audio quality) (S470). In some embodiments, updating the encoding workflow includes updating the encoding workflow to reduce processing load of the computer system (S470).

### Process S403

In some embodiments, the process S403 includes: the encoding module storing the encoded data stream in a storage device of the computer system (e.g., 101a, 101b). In some embodiments, the process S403 includes: the encoding module providing the encoded data stream to the program engine, as a response to an input capture request. In some embodiments, the process S403 includes: the encoding module providing the encoded data stream to an external device via a network (e.g., a video production server 104, a broadcast ingest server 105, a video consuming device 106a-b).

In some embodiments, the method 400 includes: the external device receiving the encoded data stream. In some embodiments, the method 400 includes: the external device processing the encoded data stream. In some embodiments, the method 400 includes: the external device broadcasting the encoded data stream.

In some embodiments, a local output includes one of a file, a callback of the program engine, a component of the encoding module (e.g., a recording component).

In some embodiments, a network output includes one of a content delivery network (CDN), an RTMP (Real-Time Messaging Protocol) endpoint device, an FTL (Faster Than Light) endpoint device, and an SRT (Secure Reliable Transport) endpoint device. In some embodiments, a CDN is a device communicatively coupled to the device 101a, 101b that is constructed to deliver a live (or pre-recorded) data stream to an end-user on demand (e.g., Twitch.tv, YouTube, Mixer, Livestream.com, and the like).

### Input Sources

In some embodiments, input sources include audio data sources (stream or file), video data sources (stream or file), image files, program data (stream or file), game telemetry (stream or file), and hardware inputs (e.g., mouse, keyboard, web camera, microphone, video card, capture card, hard drive). In some embodiments, availability of input sources is defined by received user-input of an end user of the program. In some embodiments, availability of input sources is defined by a developer of the program engine. In some embodiments, the program engine defines which inputs are to be available for use by the encoding module and by a user of the program. In some embodiments, the program is constructed to receive user selection of inputs to be used by the encoding module during the encoding process. In some embodiments, the program engine is constructed to configure the encoding module to capture at least one of input data of a web camera of the device (e.g., 101a, 101b), input data of a microphone of the device, video data of the device, and audio data of the device.

Initial Encoding Parameters

In some embodiments, the data stream is encoded at S401 in accordance with initial encoding parameters. In some embodiments, the initial encoding parameters are stored (e.g., by the encoding module, the program engine, etc.). In some embodiments, initial encoding parameters are specified by the start session request at S410. In some embodiments, initial encoding parameters are specified by the input capture request at S420. In some embodiments, initial encoding parameters are determined by the encoding module. In some embodiments, initial encoding parameters are specified by configuration data of the encoding module. In some embodiments, initial encoding parameters include at least one of: quality balance, max bitrate, buffer size, constant bitrate (CBR) encoding settings, audio codec, audio encoding format, audio encoding bitrate, audio encoding channel (e.g., stereo, mono, etc.). In some embodiments, the data stream is encoded at S401 in accordance with

Start Session Request

In some embodiments, a start session request (e.g., at S410) specifies session parameters. In some embodiments, the encoding module determines the initial encoding workflow based on the session parameters of the start session request. In some embodiments, the session parameters of the start session request include at least one of: encoding parameters, video quality constraints, auto quality constraints, CPU utilization constraints, and program (e.g., game) performance constraints.

In some embodiments, the start session request specifies a type of session. In some embodiments, the start session request specifies a streaming destination (e.g., local storage of the device 101a, 101b, the video production platform 104, the broadcast ingest server 105, the video consuming devices 106a, 106b, etc.).

### Input Capture Request

In some embodiments, a input capture request (e.g., at S420) specifies input capture parameters, and data (e.g., audio data, video data) specified by the input capture instruction is encoded in accordance with the capture parameters. In some embodiments, the capture parameters of the input capture request include at least one of: encoding parameters, video quality constraints, audio quality constraints, CPU performance constraints. In some embodiments, the input capture request specifies the data (e.g., audio, video) to be encoded. In some embodiments, the input capture request specifies at least one asset to be included in the generated encoded data stream. In some embodiments, the input capture request specifies position information of at least one asset for positing of the asset within a frame of the video stream. In some embodiments, the input capture request specifies information of at least one audio asset for inclusion within an audio stream.

In some embodiments, encoding parameters include at least one of: quality balance, max bitrate, buffer size, constant bitrate (CBR) encoding settings, audio codec, audio encoding format, audio encoding bitrate, audio encoding channel (e.g., stereo, mono, etc.).

Process S430

In some embodiments, S430 includes: determining (e.g., by using the profiling module 304) an encoding profile by querying an operating system (e.g., 130) of the computer system. In some embodiments, S430 includes: determining (e.g., by using the profiling module 304) an encoding profile by querying a registry of the operating system (OS) of the device. In some embodiments, S430 includes: determining (e.g., by using the profiling module 304) an encoding profile by querying a firmware (e.g., 140) of the device. In some embodiments, S430 includes: determining (e.g., by using the profiling module 304) an encoding profile by using a hardware interface (e.g., 111) to query hardware devices communicatively coupled to a bus (e.g., 501 of FIGS. 5A-B) of the device. In some embodiments, the hardware interface is constructed to interface with a hardware graphics processing device via an API of the graphics processing device of the device 101a, 101b. In some embodiments, the hardware interface 111 is constructed to interface with a plurality of hardware graphics processing devices via respective APIs of the graphics processing devices. In some embodiments, the hardware interface 111 is constructed to interface with a graphics processing core of a CPU of the device 101a, 101b.

Workflows and Historical Data

In some embodiments, the workflow generated at S440 specifies an assignment of at least one encoding process to at least one hardware encoding device (e.g., a hardware encoding device identified by the encoding profile generated at S430). In some embodiments, the workflow specifies an assignment of one of a graphics card hardware encoding device and a CPU hardware encoding device to the encoding process. In some embodiments, the workflow specifies an assignment of one of a plurality of graphics card hardware encoding devices to the encoding process.

In some embodiments, the encoding module 110 is constructed to access historical data that is used to determine the workflow. In some embodiments, the historical data includes historical data of the computer system hosting the encoding module no. In some embodiments, the historical data includes historical data of other computer systems. For example, for a multi-player game, the encoding module is constructed to access historical data for a plurality of user devices that have participated in the multi-player game.

In some embodiments, historical data for the computer system (e.g., user device 110) includes a set of one or more encoding workflows used by the computer system. In some embodiments, for each encoding workflow, the historical data includes associated data for the encoding workflow. In some embodiments, associated data for an encoding workflow includes at least one of: an encoding profile of the computer system at a time of use of the encoding workflow; program information of the program used with the encoding workflow; streaming feedback; program performance data; streaming performance data; encoding parameters; session parameters; a type of session; information for at least one streaming destination; user data of a user associated with a program associated with the encoding workflow; video capture parameters; video quality constraints; audio capture parameters; audio quality constraints; CPU performance constraints; CPU utilization data; resource utilization data; network performance data; video streaming constraints; audio streaming constraints; program performance constraints; program (e.g., video game) performance constraints; program performance data of other computer systems; and streaming performance data of other user devices.

In some embodiments, the encoding module updates the historical data during the encoding process. In some embodiments, the encoding module updates the historical data during the encoding process based on data received from other computer systems via the network 103.

### Process S440: Lookup

In some embodiments, S440 includes: the encoding module using a lookup table to determine the initial encoding workflow. In some embodiments, the encoding module includes a lookup table that matches encoding profiles with encoding workflows, and selects an encoding workflow that matches the encoding profile to be the initial encoding workflow.

### Process S440: Statistical Analysis

In some embodiments, S440 includes: the encoding module using a statistical analysis process to determine the initial encoding workflow. In some embodiments, the encoding module applies the statistical analysis process to the historical data for the computer system (e.g., user device 110) to determine the initial encoding workflow. In some embodiments, the encoding module accesses program performance constraints and quality constraints (e.g., video quality constraints, audio quality constraints) for the streaming session, and generates an initial encoding workflow using components identified by the first encoding profile that is likely to satisfy both the program performance constraints and quality constraints, based on analysis of the historical data.

In some embodiments, the encoding module uses the operating environment of the computer system (e.g., received streaming feedback, monitored performance, etc.) to determine selection of the initial encoding workflow.

In some embodiments, responsive to a change in operating environment of the computer system (e.g., received streaming feedback, monitored performance, etc.), the encoding module selects a new workflow to be used by performing the statistical analysis process using the information of the changed operating environment.

### Process S440: Machine Learning

In some embodiments, S440 includes: using a trained workflow selection model to select an encoding workflow based on the encoding profile. In some embodiments, S440 includes: using a trained workflow selection model to generate an encoding workflow based on the encoding profile. In some embodiments, the encoding module performs S440. In some embodiments, the workflow selection model is trained on a dataset that includes historic encoding profiles and corresponding encoding workflows, and the workflow selection model is trained to predict an encoding workflow for an input data set that represents an encoding profile.

In some embodiments, the workflow selection model is trained on a dataset that includes a plurality of rows, each row including at least one of: an encoding bitrate parameter, an actual encoding bitrate, a maximum encoding bitrate parameter, an actual maximum encoding bitrate, a frame dimensions (e.g., W×H) parameter, actual frame dimensions, an encoding input buffer size, an encoding output buffer size, an encoded image quality parameter (e.g., a Video Multimethod Assessment Fusion (VMAF) metric, a Peak Signal to Noise Ratio (PSNR) metric, a Structural Similarity index (SSIM), etc.), an actual encoded image quality metric value, a maximum CPU usage constraint, an average CPU usage constraint, a maximum monitored CPU usage, an average monitored CPU usage, a maximum RAM usage constraint, an average RAM usage constraint, a maximum monitored RAM usage, an average monitored RAM usage, a maximum GPU RAM usage constraint, an average GPU RAM usage constraint, a maximum monitored GPU RAM usage, an average monitored GPU RAM usage, a maximum packet loss constraint, an average packet loss constraint, a total packet loss constraint, a maximum monitored packet loss, an average monitored packet loss, a total monitored packet loss, a maximum packet drop constraint, an average packet drop constraint, a total packet drop constraint, a maximum monitored packet drop, an average monitored packet drop, a total monitored packet drop, a maximum frame drop constraint, an average frame drop constraint, a total frame drop constraint, a maximum monitored frame drop, an average monitored frame drop, and a total monitored frame drop, an available CPU type, a used CPU type, an available GPU type, a used GPU type, a maximum encoding time constraint, an average encoding time constraint, a total encoding time constraint, a maximum monitored encoding time, an average monitored encoding time, a total monitored encoding time, a maximum general graphics pipeline time constraint, an average general graphics pipeline time constraint, a total general graphics pipeline time constraint, a maximum monitored general graphics pipeline time, an average monitored encoding time, a total monitored general graphics pipeline time. In some embodiments, a general graphics pipeline including a video frame resizing process (e.g., resizing based on frame dimension, W×H, parameters), followed by a color conversion process, followed by an encoding process being applied to a video data stream inputted to the general graphics pipeline.

In some embodiments, the workflow selection model is trained to predict at least one of (e.g., a target variable includes at least one of): an encoding bitrate parameter, a maximum encoding bitrate parameter, a frame dimensions (e.g., W×H) parameter, a GPU type parameter (identifying which of a plurality of available GPUs to use), and at least one encoding parameter. In some embodiments, encoding parameters (that are predicted by the workflow selection module) include at least one of: quality balance, max bitrate, buffer size, constant bitrate (CBR) encoding settings (e.g., 1-pass, 2-pass, multi-pass), variable bitrate (VBR) encoding settings (e.g., 1-pass, 2-pass, multi-pass), audio codec, audio encoding format, audio encoding bitrate, audio encoding channel (e.g., stereo, mono, etc.). In some embodiments, encoding parameters include at least one of a QP (Quantizer Parameter) of I frames, a QP of P frames, and a QP of B frames. In some embodiments, encoding parameters include at least one tuning encoding parameter. In some embodiments, at least one tuning encoding parameter overrides a default encoder configuration parameter.

In some embodiments, the trained workflow selection model is constructed to predict a maximum encoding bitrate value based on at least one input variable (feature) that identifies packet loss (e.g., an actual packet loss, a packet loss constraint). In some embodiments, the trained workflow selection model is constructed to predict one or more frame dimension values based on the predicted maximum encoding bitrate value. In some embodiments, the trained workflow selection model is constructed to predict an encoding image quality parameter value based on at least one of the predicted maximum encoding bitrate value and the predicted frame dimension values. In some embodiments, the trained workflow selection model is constructed to predict a GPU selection based on at least one of the predicted maximum encoding bitrate value, the predicted frame dimension values, and the predicted encoding image quality parameter value. In some embodiments, the trained workflow selection model is constructed to predict at least one encoding parameter based on at least one of the predicted maximum encoding bitrate value, the predicted frame dimension values, the predicted encoding image quality parameter value, and the predicted GPU selection.

In some embodiments, the workflow selection model is trained on a dataset that includes historic encoding profiles and corresponding encoding workflows, and the workflow selection model is trained to predict an encoding workflow for an input data set that represents an encoding profile.

In some embodiments, the workflow determined at S440 identifies at least one value predicted by the workflow selection model.

In some embodiments, the workflow selection module receives the encoding profile determined at S430 as an input. In some embodiments, the workflow selection module receives as input at least one of: an encoding bitrate parameter, an actual encoding bitrate, a maximum encoding bitrate parameter, an actual maximum encoding bitrate, a frame dimensions (e.g., W×H) parameter, actual frame dimensions, an encoding input buffer size, an encoding output buffer size, an encoded image quality parameter (e.g., a Video Multimethod Assessment Fusion (VMAF) metric, a Peak Signal to Noise Ratio (PSNR) metric, a Structural Similarity index (SSIM), etc.), an actual encoded image quality metric value, a maximum CPU usage constraint, an average CPU usage constraint, a maximum monitored CPU usage, an average monitored CPU usage, a maximum RAM usage constraint, an average RAM usage constraint, a maximum monitored RAM usage, an average monitored RAM usage, a maximum GPU RAM usage constraint, an average GPU RAM usage constraint, a maximum monitored GPU RAM usage, an average monitored GPU RAM usage, a maximum packet loss constraint, an average packet loss constraint, a total packet loss constraint, a maximum monitored packet loss, an average monitored packet loss, a total monitored packet loss, a maximum packet drop constraint, an average packet drop constraint, a total packet drop constraint, a maximum monitored packet drop, an average monitored packet drop, a total monitored packet drop, a maximum frame drop constraint, an average frame drop constraint, a total frame drop constraint, a maximum monitored frame drop, an average monitored frame drop, and a total monitored frame drop, an available CPU type, a used CPU type, an available GPU type, a used GPU type, a maximum encoding time constraint, an average encoding time constraint, a total encoding time constraint, a maximum monitored encoding time, an average monitored encoding time, a total monitored encoding time, a maximum general graphics pipeline time constraint, an average general graphics pipeline time constraint, a total general graphics pipeline time constraint, a maximum monitored general graphics pipeline time, an average monitored encoding time, a total monitored general graphics pipeline time. In some embodiments, a general graphics pipeline including a video frame resizing process (e.g., resizing based on frame dimension, W×H, parameters), followed by a color conversion process, followed by an encoding process being applied to a video data stream inputted to the general graphics pipeline. In some embodiments, the workflow selection module receives input from at least one of the program (e.g., 102a) of the computer system, a program engine (e.g., 120a) of the computer system, the encoding module no, a storage medium of the computer system (e.g., 505), an operating system (e.g., 130) of the computer system, a device driver (e.g., 131) of the computer system, and a network interface (e.g., 132) of the computer system. In some embodiments, the workflow selection module receives input from at least one of the program (e.g., 102b) of the computer system, a program engine (120b) of the computer system, the encoding module 110, a storage medium of the computer system (e.g., 505), a firmware (e.g., 140) and a network (e.g., 103).

In some embodiments, S440 includes: the encoding module using a machine learning process to determine the initial encoding workflow. In some embodiments, the encoding module applies the machine learning process to historical data for the computer system (e.g., user device 110) to determine the initial encoding workflow. In some embodiments, the encoding module accesses program performance constraints and quality constraints (e.g., audio quality constraints, video quality constraints) for a streaming session, and generates an initial encoding workflow using components identified by the first encoding profile that is likely to satisfy both the program performance constraints and quality constraints, based on application of a trained machine learning model to the historical data.

In some embodiments, the encoding module selects at least one feature from the historical data for the user device and selects at least one target relating to at least one of program performance constraints and quality constraints, generates a machine learning model for scoring encoding workflows based on the selected features and targets, and trains the model. In some embodiments, the encoding module includes a model for scoring encoding workflows, scores a plurality of encoding workflows by using the model, and selects a workflow to be used as the initial encoding workflow based on the workflow scores generated by the model, wherein the model generates each score based on features included in the historical data that relate to a current operating environment of the user device during the scoring process.

In some embodiments, responsive to a change in operating environment of the user device (e.g., received streaming feedback, monitored performance, etc.), the encoding module selects a new workflow to be used by scoring workflows using the model and selecting the new workflow based on the new scores.

### Process S401

In some embodiments, S401 includes: a synchronizer (e.g., 306) synchronizing input sources specified by an input capture request received from the program engine, and providing synchronized raw data of the input sources to at least a first hardware encoder of the initial encoding workflow (e.g., the workflow determined at S440); an interleaver (e.g., 307) of the encoding module receiving encoded video frame generated by at least the first hardware encoder from the synchronized raw data and interleaving the encoded video frames and providing the interleaved encoded video frames to an output packetizer (e.g., 308) of the encoding module; and the output packetizer re-packetizing the interleaved encoded video frames for transport to a specified output destination.

### Feedback

In some embodiments, the method includes: updating the encoding (S470). In some embodiments, S470 includes: updating the encoding workflow (determined at S440), and updating the encoding by using the updated encoding workflow. In some embodiments, the encoding workflow (determined at S440) is incrementally updated. In some embodiments, the encoding workflow (determined at S440) is incrementally updated within a time window. In some embodiments, the method 400 includes: the encoding module determining streaming feedback information (process S450). In some embodiments, the method 400 includes: the encoding module determining streaming feedback information by performing an internal bandwidth test (process S450). In some embodiments, the method 400 includes: the encoding module receiving streaming feedback information (process S450). In some embodiments, the method 400 includes: the encoding module receiving CPU utilization data (processing load information) of the device (e.g., gaming system) (process S460). In some embodiments, S470 includes: the encoding module updating the encoding workflow (determined at S440) by applying one of the machine learning process and the statistical analysis process to at least one of the streaming feedback information, the CPU utilization data, and the encoding profile.

In some embodiments, streaming feedback information identifies health of outgoing content. In some embodiments, streaming feedback information specifies a type of at least one streaming destination. In some embodiments, streaming feedback information specifies at least one of latency, jitter, round-trip time, and measured bit rate of the streaming process.

In some embodiments, updating the encoding workflow includes: changing encoders. In some embodiments, updating the encoding workflow includes: changing encoding parameters.

In some embodiments, the encoding module receives the CPU utilization data (processing load information) of the device from the operating system (e.g., 130) of the computer system (e.g., 101a). In some embodiments, the encoding module receives the CPU utilization data of the computer system from the firmware (e.g., 140) (e.g., 101b).

In some embodiments, the encoding module receives the streaming feedback information from an output destination device (e.g., the video production platform 104, the broadcast ingest server 105, the video consuming device 106a-b, a CDN). In some embodiments, the encoding module receives the streaming feedback information from a hardware component of the computer system 101a-b. In some embodiments, the encoding module receives the streaming feedback information from the program engine. In some embodiments, the encoding module receives the streaming feedback information from the operating system (e.g., 130) of the computer system (e.g., 101a). In some embodiments, the encoding module receives the streaming feedback information from the firmware (e.g., 140) of the computer system (e.g., 101b).

In some embodiments, the machine learning process determines an updated encoding workflow that optimizes a selected optimization target, wherein the target is updated based on the streaming feedback information and the CPU utilization data (processing load information). In some embodiments, the statistical analysis process determines an updated encoding workflow that optimizes a selected optimization target, wherein the target is updated based on the streaming feedback information and the CPU utilization data (processing load information).

In some embodiments, the machine learning process generates an updated workflow that satisfies both CPU performance constraints and streaming quality constraints, and updates a current workflow as monitored CPU utilization and streaming performance changes.

In some embodiments, the first encoding workflow (determined at S440) is generated by using the encoding profile and initial encoding parameters. In some embodiments, the first encoding workflow is updated based on the first encoding profile, streaming quality feedback, monitored CPU utilization of the computer system (e.g., 101a-b), streaming performance constraints, and CPU utilization constraints.

### Clips

In some embodiments, the input capture request is a request to generate and stream a highlight clip. In some embodiments, the clipping and highlights module 302 processes the request to generate and stream a highlight clip. In some embodiments, the program engine provides the encoding module with the request to generate and stream a highlight clip in response to a particular program event (e.g., a gaming event of a video game, a debugging event, a program fault, a program failure, a program error, and the like). In some embodiments, the program engine saves a video clip of a predetermined length to a buffer, and specifies the buffer in the request to the encoding module.

Insert Asset

In some embodiments, program logic (e.g., game logic) of the program engine controls selective insertion of assets (e.g., audio assets, video assets) into the encoded data stream.

In some embodiments, the input capture request is a request to insert at least one asset into the encoded data stream. In some embodiments, the program engine provides the encoding module with the request to insert an asset in response to a particular program event (e.g., a gaming event of a video game, a debugging event, a program fault, a program failure, a program error, and the like).

As an example of asset insertion, in response to a particular program event (e.g., a gaming event of a video game, a debugging event, a program fault, a program failure, a program error, and the like), the program uses the API of the GSDK module to insert an asset into the data stream.

### Tagging

In some embodiments, program logic (e.g., game logic) of the program engine controls selective tagging of the encoded data stream with game telemetry.

In some embodiments, the input capture request is a request to tag the encoded data stream with at least one set of tag data. In some embodiments, the program engine provides the encoding module with the request to tag the data stream in response to a particular program event (e.g., a gaming event of a video game, a debugging event, a program fault, a program failure, a program error, and the like).

In some embodiments, the program engine provides the encoding module with a tag request (separate from an input capture request) to tag the data stream with specified tag data in response to a particular program event (e.g., a gaming event of a video game, a debugging event, a program fault, a program failure, a program error, and the like). In some embodiments, the tag data includes game telemetry. In some embodiments, the program engine provides the encoding module with the tag request by using the API module 112.

Programmatic Video Editing

In some embodiments, the encoding module receives a video editing request (separate from an input capture request) to edit at least one scene of the data stream in accordance with at least one editing instruction. In some embodiments, the video editing request is provided by the program engine. In some embodiments, the video editing request is provided by the program engine in response to a particular program event (e.g., a gaming event of a video game, a debugging event, a program fault, a program failure, a program error, and the like). In some embodiments, the video editing request is provided by a game server. In some embodiments, the video editing request is provided by a module external to the program (e.g., 102a, 102b). In some embodiments, the video editing request is provided by a system external to the computer system (e.g., I101a, 101b). In some embodiments, the video editing request is provided by a compositing system. In some embodiments, the video editing request is a scene change request. In some embodiments, the video editing request is asset insertion request. In some embodiments, the program engine provides the encoding module with the video editing request by using the API module 112.

### Encoders

In some embodiments, hardware encoding devices include dedicated processors that use a designated process to encode data (e.g., video data, audio data, data of video assets, data of audio assets) into streamable content. In some embodiments, the encoding module is constructed to access and use one or more hardware encoding devices. In some embodiments, hardware encoding devices include Nvidia Nvenc, Intel, and AMD hardware encoding devices. In some embodiments, hardware encoding devices include the Nvidia Nvenc, which is constructed to perform video encoding, offloading this task from the CPU. In some embodiments, hardware encoding devices include the Intel Quicksync Video, which is a dedicated video encoding and decoding hardware core. In some embodiments, hardware encoding devices include the AMD Video Coding Engine (VCE), which is a full hardware implementation of the video codec H.264/MPEG-4 AVC. In some embodiments, the computer system (e.g., 101a, 101b) includes at least one device driver for each hardware encoding device.

In some embodiments, software encoding capabilities include software encoder programs that run on the computer system (e.g., 101a, 101b) that is constructed to encode video and data into streamable content. In some embodiments, the encoding module is constructed to access and use one or more software encoders. In some embodiments, software encoders include AVI encoders H.264 encoders, VP8/VP9 Encoders, and H.265 Encoders.

### Components

Embodiments herein provide clipping/highlights, wherein the encoding module keeps a buffer of video that the program engine uses to save defined segments to local disk (or to send defined segments to networked devices, such as cloud storage or social media systems) either automatically or in response to user input (e.g., by using a clipping module 302).

Embodiments herein provide recording, wherein the encoding module records an entire composited video stream output directly to a hard disk of the device (e.g., 101a, 101b) (e.g., by using recording module 303).

Embodiments herein provide profiling/auto-configuration, wherein the encoding module automatically profiles the device (e.g., 101a, 101b) and configures itself to encode live streams or video clips with reduced impact to a gaming experience (e.g., by using the profiling module 304).

Embodiments herein provide 3^{rd} party/Contextual Data integration, wherein the encoding module emits out-of-band or contextual information integrated into the output video stream to be consumed by a configured output destination device. In some embodiments, the encoding module receives an asset insertion request (e.g., from the program, an external computing system, etc.) and integrates an asset identified by the asset insertion request into the output video stream.

Embodiments herein provide overlay composition, wherein the encoding module composites additional elements (as defined by at least one of received user-input and the program engine) onto the final video stream output.

Embodiments herein provide interactivity, wherein the encoding module receives commands or information from an output destination device (or other external source) that are processed by the encoding module and presented to the program engine to change the environment in which the encoding module is embedded, thereby affecting the final output stream. In some embodiments, the method 400 includes: an output destination device providing information to the encoding module (via the computer system, e.g., 101a, 101b), wherein the encoding module updates the encoding based on the information provided by the output destination device.

Embodiments herein provide interactivity, wherein the encoding module receives commands or information from an output destination device (or other external source) that are processed by the encoding module to update the encoding process performed by the encoding module, thereby affecting the final output stream.

Embodiments herein provide interactivity, wherein the encoding module receives commands or information from the program engine that are processed by the encoding module to update the encoding process performed by the encoding module, thereby affecting the final output stream.

Embodiments herein provide interactivity and overlay composition, wherein the encoding module receives destination information (e.g., viewer count, and the like) from a streaming destination device (e.g., the video production platform 104, the broadcast ingest server 105, the video consuming device 106a-b, a CDN), and the destination information is processed by the program engine (e.g., 120a, 120b), and used to customize an overlay composition to be applied to the final output stream. In some embodiments, the method 400 includes: a streaming destination device providing information to the encoding module (via the computer system, e.g., 101a, 101b), wherein the encoding module updates the final output stream (provided at S403) based on the destination information.

Embodiments herein provide interactivity and overlay composition, wherein the encoding module receives destination information (e.g., viewer count, and the like) from a streaming destination device (e.g., the video production platform 104, the broadcast ingest server 105, the video consuming device 106a-b, a CDN), and the destination information is processed by the program engine (e.g., 120a, 120b), and used by the encoding module to customize an overlay composition to be applied to the final output stream. In some embodiments, the method 400 includes: a streaming destination device providing information to the encoding module (via the computer system, e.g., 101a, 101b), wherein the encoding module customizes an overlay composition to be applied to the final output stream (provided at S403) based on the information provided by the streaming destination device.

System Architecture

FIG. 5A is a diagram depicting system architecture of device 101a, according to embodiments. FIG. 5B is a diagram depicting system architecture of device 101b, according to embodiments.

In some embodiments, the systems of FIGS. 5A-B are implemented as single hardware devices. In some embodiments, the systems of FIGS. 5A-B are implemented as a plurality of hardware devices.

In some embodiments, the bus 501 interfaces with the processors, the main memory 522 (e.g., a random access memory (RAM)), a read only memory (ROM) 504, a processor-readable storage medium 505, and a network device 511. In some embodiments, bus 501 interfaces with at least one of a display device 591 and a user input device 592. In some embodiments, the display device 591 includes at least one hardware encoding device.

In some embodiments, the processors 503A-503N include one or more of an ARM processor, an X86 processor, a GPU (Graphics Processing Unit), and the like. In some embodiments, at least one of the processors includes at least one arithmetic logic unit (ALU) that supports a SIMD (Single Instruction Multiple Data) system that provides native support for multiply and accumulate operations. In some embodiments, at least one processor includes at least one hardware encoding device.

In some embodiments, at least one of a central processing unit (processor), a GPU, and a multi-processor unit (MPU) is included.

In some embodiments, the processors and the main memory form a processing unit 599. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some embodiments, the processing unit includes at least one arithmetic logic unit (ALU) that supports a SIMD (Single Instruction Multiple Data) system that provides native support for multiply and accumulate operations. In some embodiments the processing unit is a Central Processing Unit such as an Intel processor. In other embodiments, the processing unit includes a Graphical Processing Unit such as NVIDIA NVENC.

The network adapter device 511 provides one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs. The processor-readable storage medium is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

In some embodiments, the processor-readable storage medium 505 of device iota includes machine-executable instructions (and related data) for the operating system 130, software programs 513, device drivers 514, and the program 101a, as shown in FIG. 5A.

In some embodiments, the processor-readable storage medium 505 of device 101b includes machine-executable instructions (and related data) for the firmware 140, and the program 102b, as shown in FIG. 5B.

In some embodiments, the hardware interface 111 of FIGS. 1A-B includes device drivers for communicating with each hardware encoding device that is communicatively coupled to the bus 501. In some embodiments, the hardware interface 111 of FIGS. 1A-B includes computer-executable program instructions for communicating with at least one hardware encoding device that is communicatively coupled to the bus 501 by using an API of the hardware encoding device.

In some embodiments, a method includes: generating machine-executable instructions of a program, that when executed by one or more processors of a computer system, cause the computer system to perform the method 400. In some embodiments, generating the machine-executable instructions of the program include: compiling source code of the program by using an encoding library of a software development kit (SDK). In some embodiments, the encoding library includes source code for an encoding module (e.g., 110). In some embodiments, the encoding module of the encoding library is constructed to perform at least one process of the method 400. In some embodiments, generating the machine-executable instructions of the program include: generating object code for a program engine of the program; and linking the object code for the program engine with encoding module object code of an encoding module (e.g., 110). In some embodiments, the encoding module object code is included in a software development kit (SDK). In some embodiments, the encoding module (of the encoding module object code) is constructed to perform at least one process of the method 400.

4. Machines

The systems and methods of some embodiments and variations thereof can be embodied and/or implemented at least in part as a machine configured to receive a computer-readable medium storing computer-readable instructions. The instructions are preferably executed by computer-executable components. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

5. Conclusion

As a person skilled in the art will recognize from the previous detailed description and from the figures and claims, modifications and changes can be made to the embodiments disclosed herein without departing from the scope defined in the claims.

What is claimed is:

1. A non-transitory computer-readable storage medium comprising:
machine-executable instructions of a program, that when executed by one or more processors of a computer system, cause the computer system to at least:
provide a program engine that generates a video stream;
provide an encoding module that encodes the video stream by using a hardware encoding device of the computer system, in accordance with program information provided by the program engine, and
provide at least a portion of the encoded video stream to an output,
wherein the program is a video game.

2. The storage medium of claim 1, wherein the encoding module is constructed to:
obtain updated program information from the program engine; and
update an encoding workflow based on the updated program information and encode the video stream in accordance with the updated encoding workflow.

3. The storage medium of claim 2, wherein the program information identifies a color pallet, and wherein the encoding workflow is updated based on the color pallet.

4. The storage medium of claim 2, wherein the program information identifies an amount of motion, and wherein the encoding workflow is updated based on the amount of motion.

5. The storage medium of claim 2, wherein the program information identifies at least one object in the video stream, and wherein the encoding workflow is updated based on the identified at least one object.

6. The storage medium of claim 2, wherein the program information identifies an importance level, and wherein the encoding workflow is updated based on the identified importance level.

7. The storage medium of claim 1, wherein the program information includes at least one of an encoding session start request and an input capture request.

8. The storage medium of claim 2, wherein updating the encoding workflow comprises: updating the encoding workflow to enhance video quality.

9. The storage medium of claim 2, wherein updating the encoding workflow comprises: updating the encoding workflow to reduce processing load of the computer system.

10. The storage medium of claim 1, wherein the encoding module is constructed to determine a video stream encoding profile of the computer system, use a trained workflow selection model to select a video stream encoding workflow based on the determined video stream encoding profile, and use the selected video stream encoding workflow to encode the video stream, wherein the workflow selection model is trained on a dataset that includes historic encoding profiles and corresponding encoding workflows, wherein the workflow selection model is trained to predict an encoding workflow for an input data set that represents an encoding profile.

11. The storage medium of claim 10, wherein the encoding profile identifies at least one of hardware encoding devices, software encoding capabilities, input sources, local outputs, and network outputs of the computer system.

12. The storage medium of claim 1, wherein the encoding module is constructed to determine a video stream encoding profile of the computer system, determine a video stream encoding workflow based on the determined video stream encoding profile and initial encoding parameters, and use the selected video stream encoding workflow to encode the video stream.

13. The storage medium of claim 1,
wherein the encoding module is constructed to:
obtain streaming feedback information;
update an encoding workflow based on the streaming feedback information and encode the video stream in accordance with the updated encoding workflow.

14. The storage medium of claim 1,
wherein the encoding module is constructed to:
obtain processing load information for the computer system;
update an encoding workflow based on the processing load information and encode the video stream in accordance with the updated encoding workflow.

15. The storage medium of claim 1, wherein providing at least a portion of the encoded video stream to an output comprises: providing at least a portion of the encoded video stream to an output in response to an instruction received from the program engine.

16. The storage medium of claim 1, wherein providing at least a portion of the encoded video stream to an output comprises: providing at least a portion of the encoded video stream to an output in response to detection of a debugging event of the program engine.

17. The storage medium of claim 1, wherein the encoding module includes hardware encoding device application programming interfaces (APIs) for a plurality of hardware encoding devices.

18. The storage medium of claim 1, wherein the encoding module includes a plurality of versions of APIs for at least one hardware encoding device, wherein at least one API is included in a sandbox application.

19. A method comprising: with a computer system running a video game program that includes a video game program engine and an encoding module:
with the program engine, generating a video stream;
with the encoding module, encoding the video stream by using a hardware encoding device of the computer system, in accordance with program information provided by the program engine, and
providing at least a portion of the encoded video stream to an output,
wherein the program information identifies content of the video stream.

20. A computer system comprising:
a hardware encoding device;
at least one device driver for the hardware encoding device;
a processor;
a memory;
an operating system; and
a video game program that includes a video game program engine and a video encoding module,
wherein the video encoding module comprises hardware encoding device application programming interfaces (APIs) for a plurality of hardware encoding devices, wherein the APIs for the plurality of hardware encoding devices includes: a plurality of versions of an API for the hardware encoding device of the computer system, wherein at least one API for the hardware encoding device is included in a sandbox application,
wherein the program engine is constructed to generate a video stream,
wherein the encoding module is constructed to encode the video stream by using at least one of the APIs for the hardware encoding device of the computer system, in accordance with program information provided by the program engine, and
wherein the computer system is constructed to provide at least a portion of the encoded video stream to an output, and
wherein the program information identifies content of the video stream.
